(19) United States
(12) Patent Application Publication
(10) Pub. No.: US 2011/0071856 A1
(43) Pub. Date: Mar. 24, 2011

(54) SYSTEM AND METHOD FOR DYNAMIC REAL TIME INSURANCE LITIGATION MANAGEMENT

(76) Inventors: Mary B. Nasenbenny, La Grange, IL (US); Willis Duane Schmidt, JR., Hamden, CT (US); Larry Allen Wallace, JR., Praireville, LA (US)

(21) Appl. No.: 12/565,212

(22) Filed: Sep. 23, 2009

(51) Int. Cl. G06Q 10/00; G06Q 40/00

(52) U.S. Cl. 705/4; 705/7; 705/311

(57) ABSTRACT

According to some embodiments, for each of a plurality of insurance claims, an insurance claim file is established and associated with: (i) a litigation matter, (ii) a remote legal representative, and (iii) a remote claim adjuster. Hours associated with the remote legal representative may be tracked and allocated to insurance claim files as appropriate. Legal events associated with the litigation matter may also be tracked, wherein at least some of the legal events are associated with a stored document accessible to the legal representative and not accessible to the claim adjuster. A first legal event associated with a first insurance claim file may be evaluated based on a pre-determined rule, and, responsive to the evaluation, an alert may be transmitted to the remote claim adjuster associated with the first insurance claim file.

### BACKGROUND

An enterprise might need to manage a substantial number of litigations and potential litigations. For example, an insurance company might be associated with thousands of pending and potential civil court cases. Moreover, different parties within an enterprise may need to coordinate and exchange information about those litigations. For example, a claims adjuster or handler and legal representative associated with an insurance company may simultaneously work to resolve an insurance case file associated with a pending litigation.

In connection with the litigations, the claims adjuster and legal representative may need to periodically store and access documents associated with the case (e.g., medical records and accident reports). The legal representative might also need to track the amount of time he or she spends on a particular case as well as maintain a schedule including the relevant court dates, events, and deadlines. Although these tasks can be performed manually (e.g., via notations in a physical file), such an approach can be difficult when there a relatively large number of cases being handled. Moreover, manually maintaining the information can be a time consuming and error prone process.

In addition, a single enterprise might have offices located in different regions, and it may be difficult to coordinate efforts and gather information across those offices. For example, an insurance company might have litigations currently pending in various state courts (and each state court might be associated with a different legal representative who is admitted in that jurisdiction).

### SUMMARY OF THE INVENTION

According to some embodiments, a communication device is to receive information about a plurality of insurance claims, and a processor is coupled to the communication device. A storage device in communication with said processor stores instructions adapted to be executed by said processor to, for each of the plurality of insurance claims, establish an insurance claim file associated with: (i) a litigation matter, (ii) a remote legal representative, and (iii) a remote claim adjuster. Hours associated with the remote legal representative are tracked and allocated to insurance claim files as appropriate. Legal events associated with the litigation matter are also tracked, wherein at least some of the legal events are associated with a stored document accessible to the legal representative and not accessible to the claim adjuster. A first legal event associated with a first insurance claim file is evaluated based on a pre-determined rule, and, responsive to the evaluation, an alert is transmitted to the remote claim adjuster associated with the first insurance claim file.

Still other embodiments are associated with a document input engine to generate document files for a plurality of insurance claim files, wherein each insurance claim file is associated with: (i) a litigation matter, (ii) a remote legal representative, and (iii) a remote claim adjuster. A client profile engine will: (i) track hours associated with the remote legal representative and allocate the tracked hours to the insurance claim files as appropriate, (ii) track legal events associated with the litigation matters, wherein at least some of the legal events are associated with a stored document accessible to the legal representative and not accessible to the claim adjuster, (iii) evaluate a first legal event associated with a first insurance claim file based on a pre-determined rule, and (iv) responsive to the evaluation, transmit an alert to the remote claim adjuster associated with the first insurance claim file. Moreover, a resources layer is provided to store the client profiles and the generated document files.

Other embodiments include: means for establishing an insurance claim file, for each of a plurality of insurance claims, associated with: (i) a litigation matter, (ii) a remote legal representative, and (iii) a remote claim adjuster; means for tracking hours associated with the remote legal representative and allocating the tracked hours to insurance claim files as appropriate; means for storing a document in a database in connection with an insurance claim file, wherein the stored document is accessible to the legal representative and not accessible to the claim adjuster; means for tracking legal events associated with the litigation matter, wherein at least some of the legal events are associated with the stored document; means for evaluating a first legal event associated with a first insurance claim file based on a pre-determined rule; and, responsive to the evaluation, means for transmitting an alert to the remote claim adjuster associated with the first insurance claim file.

In some embodiments, a communication device associated with a central litigation management server receives information from and/or transmits information to remote devices. The information may be exchanged, for example, via public and/or proprietary communication networks.

A technical effect of some embodiments of the invention is an improved and automated litigation management system for insurance companies and legal professionals. Moreover, some embodiments may provide benefits, such as automated notifications, for claim adjusters. With this and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is block diagram of a litigation management system in accordance with some embodiments.

FIG. 2 illustrates a method according to some embodiments of the present invention.

FIG. 3 is block diagram of a litigation management system in accordance with some embodiments.

FIG. 4 is a conceptual architecture diagram according to some embodiments of the present invention.

FIG. 5 illustrates an insurance claim document input process in accordance with some embodiments.

FIG. 6 is a block diagram of a data flow according to some embodiments of the present invention.

FIGS. 7 through 9 illustrate an insurance claim processing flow in accordance with some embodiments.

FIG. 10 illustrates a system wherein a litigation management system is integrated with an email application according to some embodiments.

FIG. 11 illustrates a system wherein a litigation management system is integrated with a word processing application according to some embodiments of the present invention.

FIG. 12 illustrates a system wherein a litigation management system is integrated with a calendaring application according to some embodiments.

FIG. 13 is a system diagram demonstrating connections between litigation management system components according to some embodiments.

FIG. 14 is a business model view associated with a litigation management system according to some embodiments of the present invention.

FIG. 15 is a block diagram of a litigation management apparatus in accordance with some embodiments of the present invention.

FIG. 16 is a tabular view of a portion of an insurance claim file database in accordance with some embodiments of the present invention.

FIG. 17 is an example of a legal representative user interface display according to some embodiments.

FIG. 18 is an example of a claim adjuster user interface display according to some embodiments.

### DETAILED DESCRIPTION

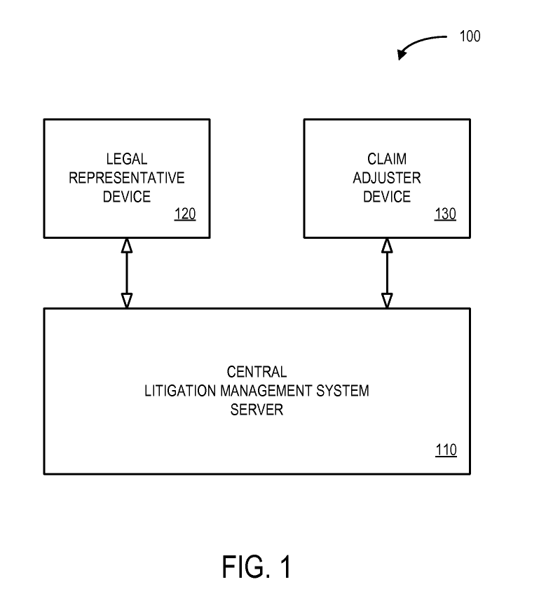

To address some of the problems described in the background section of this application, a central, automated insurance litigation management system may be provided. For example, FIG. 1 is block diagram of an insurance litigation management system 100 in accordance with some embodiments. In particular, a central litigation management system server 110 communicates with a remote legal representative device 120 and a remote claim adjuster device 130. The central litigation management server 110, legal representative device 120, and claim adjuster device 130 may then operate in accordance with any of the embodiments described herein. As used herein, a device may be “remote” from the central litigation management system server 110 in that it is physically located distant from the server 110 and/or in that it communicates with the server 110 via one or more communication networks.

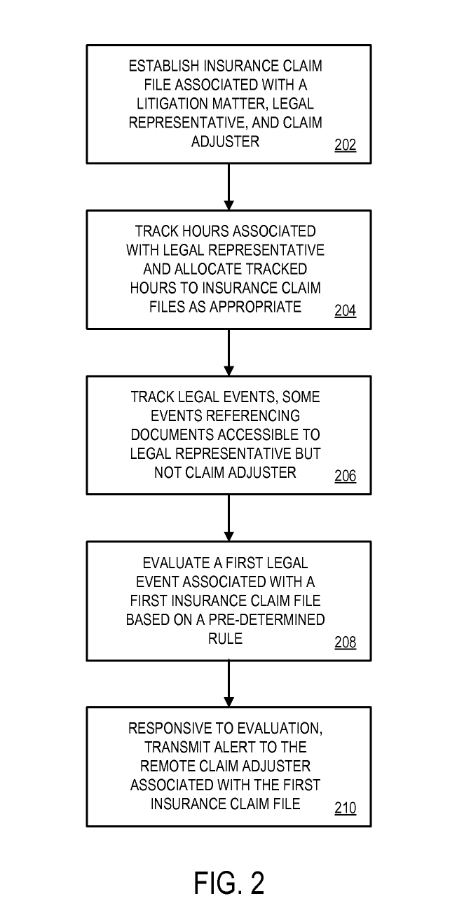

FIG. 2 illustrates one method that might be performed, for example, by the central litigation management server 110 described with respect to FIG. 1 according to some embodiments. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At 202, for each of a plurality of insurance claims, an insurance claim file may be established and associated with: (i) a litigation matter, (ii) a remote legal representative, and (iii) a remote claim adjuster. Note that as used herein, a “potential litigation” or “litigation matter” might be associated with any type of court case (including future, pending, and/or settled litigation matters), arbitration, or other methods of dispute resolution. Moreover, an insurance claim might be associated with a property and causality insurance claimant, a property and causality insurance defendant, a workers compensation claim, and/or an automobile insurance claim.

The remote legal representative might, for example, be associated with an insurance company and work on behalf of an insurance claimant. The remote legal representative could be, for example, an attorney, a paralegal, a legal secretary, or an administrator. The remote claim adjustor might, for example, work for the insurance company and attempt to settle insurance claims.

At 204, hours associated with the remote legal representative may be tracked and allocated to insurance claim files as appropriate. For example, attorney time might be tracked based on the cases he or she works on during the day. Note that, according to some embodiments, the tracked hours associated with the remote legal representative are allocated to insurance claim files in accordance with at least one compliance rule.

A central litigation management server may store documents in a database in connection with an insurance claim file, wherein the stored document is accessible to the legal representative and not accessible to the claim adjuster. For example, a confidential memo might be accessible to the attorney working on the case but not to the claim adjuster. Note that as used herein, the term “document” may refer to any type of data file, such as a word processing file, a spreadsheet, an image or video file, or an audio file. By way of example, a stored document might be associated with an interrogatory, a court pleading, a medial document, an accident report, a police record, a deposition, a court ruling, and/or a court order.

At 206, legal events associated with the potential litigation may be tracked, wherein at least some of the legal events are associated with the stored document. A legal event might be associated with, for example, a court calendar or docket date, a response deadline, a court ruling, and/or a court order. According to some embodiments, legal events are automatically tracked based upon information provided by a third party service (e.g., a third party service might calculate when a filing is due based the rules of procedure for courts in a particular state or other jurisdiction).

At 208, a first legal event associated with a first insurance claim file may be evaluated based on a pre-determined rule. For example, a central litigation management system service 110 might determine that a court appearance will be required in two weeks. Responsive to the evaluation, at 210 an alert is transmitted to the remote claim adjuster associated with the first insurance claim file. The alert transmitted to the remote claim adjuster might be associated with, for example, an email message, a change in the legal representative (e.g., when a new attorney is assigned to the case), or a reminder associated with a legal event.

According to some embodiments, a central litigation management server may also generate reports. For example, a report might be generated to provide a quality scorecard, a financial average (e.g., an average settlement cost in a particular state), or a cycle time average (e.g. an average amount of time it takes to settle particular types of insurance claims). Note that such reports may represent information gathered across at least one of: (i) a plurality of remote legal representatives, (ii) a plurality of remote claim adjusters, and/or (iii) a plurality of insurance claim types.

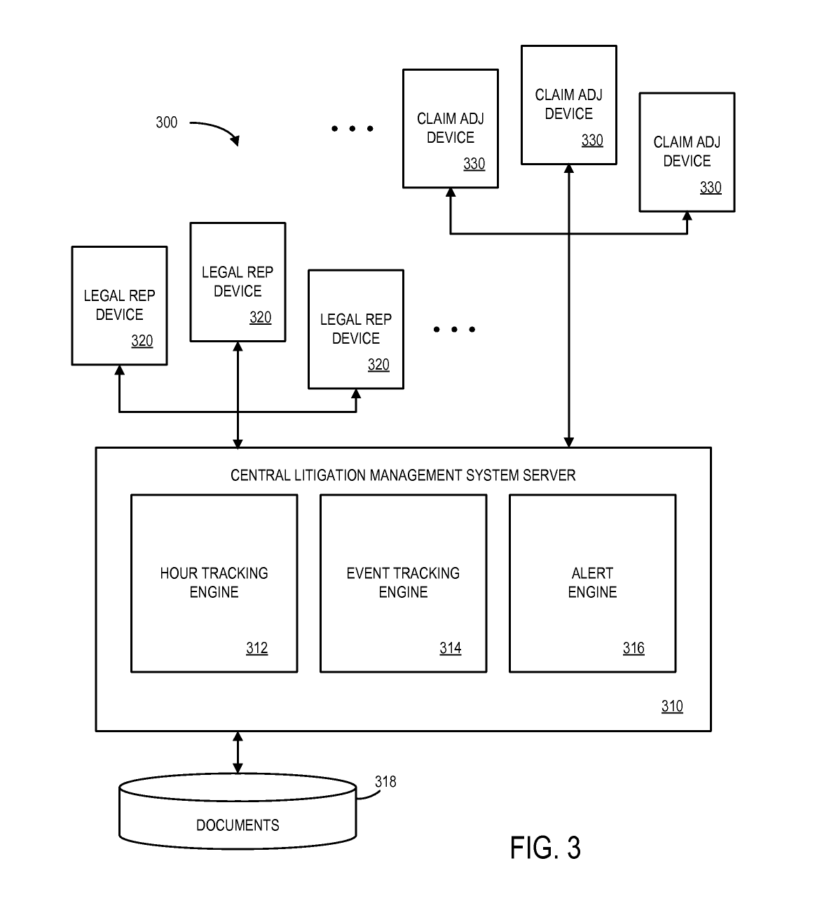

FIG. 3 is block diagram of a litigation management system 300 in accordance with some embodiments. In this case, a central litigation management system server 310 communicates with a number of remote legal representative devices 320 and remote claim adjuster devices 330. The central litigation management server 310, legal representative devices 320, and claim adjuster devices 330 may then facilitate an automated management of litigations and potential litigations. As used herein the term “automated” indicates that at least some part of a step associated with a process or service is performed with little or no human intervention. By way of examples only, the central litigation management server 310, legal representative devices 320, and claim adjuster devices 330 might be associated and/or communicate with a Personal Computer (PC), a notebook computer, a Personal Digital Assistant (PDA) an enterprise server, and/or a database farm.

Any of the devices described in connection with the system 300 may access information in one or more databases, such as a documents database 318. The databases may include, for example, information about insurance claims and litigations associated with various offices or jurisdictions. Moreover, any of the devices may exchange information via a communication network. As used herein, devices (including those associated with the central litigation management system server 310 and any other device described herein) may exchange information via any communication network, such as a Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a wireless LAN network, and/or an Internet Protocol (IP) network such as the Internet, an intranet, or an extranet. Note that any devices described herein may communicate via one or more such communication networks.

The devices of FIG. 3 might, according to some embodiments, be accessible via a Graphical User Interface (GUI). The GUI might be used, for example, to dynamically display information about existing insurance claims and litigations, to receive indications of new insurance claims and litigations, to provide alerts to legal representatives and claims adjusters, and/or to generate or display reports about insurance claims and litigations.

Although a single central litigation management system server 310 is shown in FIG. 3, any number of such devices may be included. Moreover, various devices described herein might be combined or co-located according to embodiments of the present invention.

The central litigation management system server 310 might include, for example, a communication device to receive information from a plurality of remote devices. The central litigation management system server 310 might further include a processor coupled to the communication device and a storage device in communication with the processor and storing instructions adapted to be executed by said processor to facilitate the automated management of litigations in accordance with any of the embodiments described herein.

The central litigation management system server 310 might also include, for example, an hour tracking engine 312 to allocate time worked to the appropriate insurance files, an event tracking engine 314 to schedule and monitor legal events, and an alert engine 316 to transmit messages to legal representatives and/or claim adjusters based on the legal events. According to some embodiments, the central litigation management system server 310 is also associated with a document input engine to generate document files for a plurality of insurance claim files.

Moreover, the central litigation management system server 310 might include a client profile engine that includes an interface to a third-party court calendaring service. The client profile engine might further include an interface to a word processing application, an email application, a contact management application, and/or a user calendar application. According to some embodiments, the client profile engine further executes legal conflict of interest avoidance rules. Note that the central litigation management system server 310 might further include a resources layer to store the client profiles and the generated document files (e.g., in the documents database 318), and an access layer to support a Graphical User Interface (GUI) for the remote legal representative devices 320 and/or the remote claims adjuster devices 330. According to some embodiments, a resources layer may comprise or include a storage device or server.

In this way, the system 300 may support day-to-day operations and electronic document demands of court systems, insured's and claims customers and provide a feature-rich environment with an integrated electronic document management capability. The system 300 may also support a migration towards a paperless environment, facilitate the standardization of practices, procedures and reporting, and permit the implementation of virtual supervision and staffing models.

Note that the system 300 may provide scalability through significant automation and allow for virtual support and the centralization of processes. As a result, enterprise may be less dependent on physical locations with co-located attorneys and support staff. Further, work-from-home attorneys might be utilized to reduce office footprint (or remove some offices altogether) and service jurisdictions that might otherwise be too costly to support an office structure.

The system may also drive improved file quality and efficiency and customer service through automated diary, calendaring and time entry systems, real time notification and reporting capabilities, and substantial file supervision options. With graphically implemented application features, streamlined processes, and the ability to work anywhere, some embodiments of the present invention may reduce operating expenses and improve quality, service and work environments.

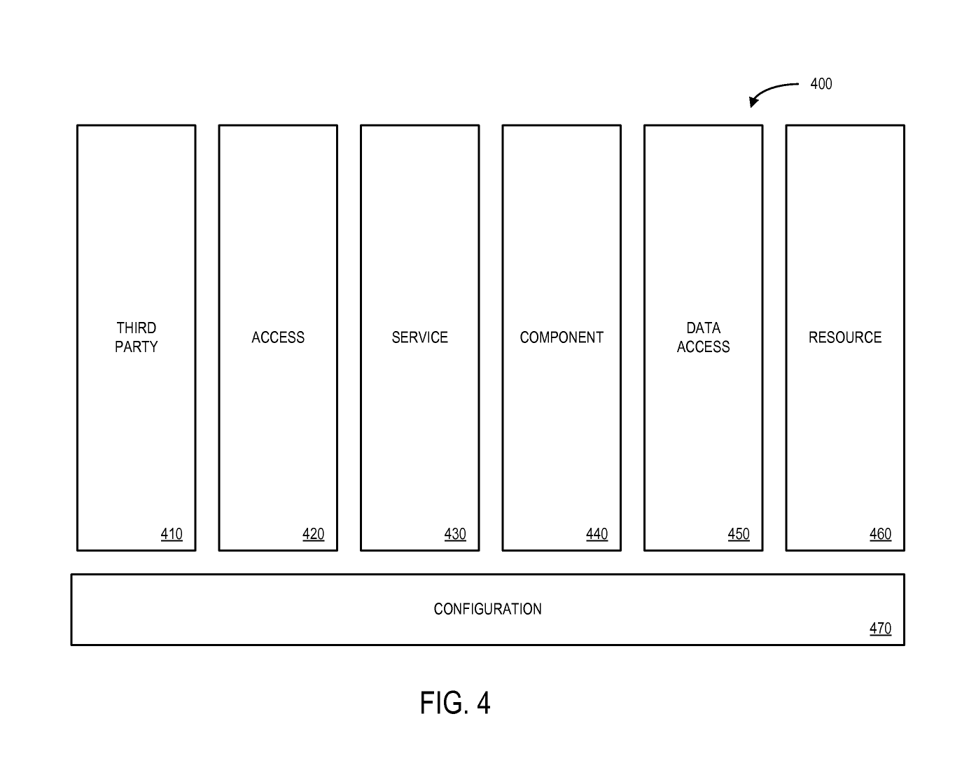

FIG. 4 is a conceptual architecture diagram 400 according to some embodiments of the present invention. In particular, a third party layer 410 may be provided to support, for example, office document scanning, and access layer 420 may support user interfaces. Client profiles may be stored at a configuration layer 470 and the client profiles case management system may be designed primarily as a client/server application using Microsoft SQL® Server as its Relational Database Management System (“RDBMS”). According to some embodiments, much of the functionality of the system may be provided within the client application. The client may be, for example, written primarily in PowerBuilder, Visual Basic, and .NET. This application may provide, for example, some or all of the following functionality: docketing, calendaring, and scheduling; task/to-do/tickler management; contact management and related-party functions; email and messaging management; time capture and time entry system; document management; key word searching; document assembly; conflict of interest/conflict avoidance; case information tracking/law type information management; case information reporting/management reporting; and Microsoft Exchange/Outlook® integration.

The access layer 420 may also support applications associated with workers compensation claims, property claims, and general liability claims. The services layer 430 may include components such as: a client profiles scanning service to direct scanned document to proper users for review and to add to case file; a client profiles indexing service to index documents for fast full text searching; a client profiles polling service to periodically poll Microsoft Exchange® for emails and calendar events for the purpose of synchronizing with client profiles; and a client profiles synchronization service to synchronize client profiles email and calendar functionality with Microsoft Exchange®. The services layer 430 may further include a data service to retrieve claim data specific to a case based on a claim number.

The component layer 440 may further support Microsoft Message Queuing (“MSMQ”) to synchronize to the MS Exchange server with client profiles. according to some embodiments, the resource layer 460 may support: case data extract to extract case data (e.g., a case name and claim number) to be sent to the vendor(s) for indexing and claim matching purposes; document storage to provide storage for all case related documentation; a Microsoft Exchange® integration point for email and calendaring; a claims data warehouse to store client profile data (case details, etc.) that may be loaded to the claims data warehouse for analytic reporting; and active directory to establish an identity for a logged on user; and a client profiles database storing case details, document metadata, and required application data.

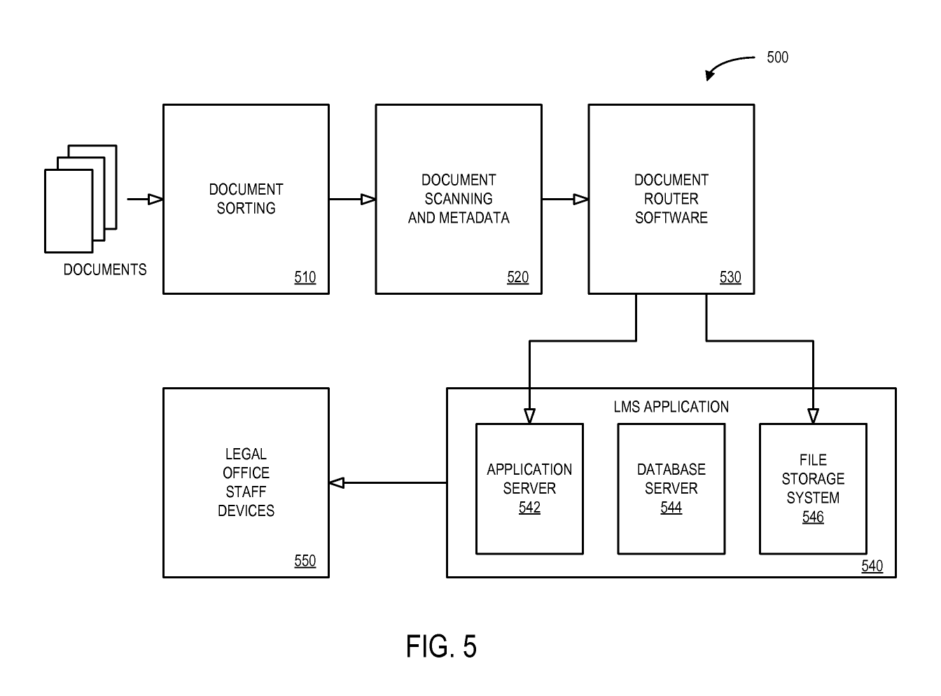

According to some embodiments, documents may be sent to a specific legal office or a state hub for scanning (e.g., via email, fax machines, and postal mail). In other embodiments, each legal office might receive and scan its own documents. FIG. 5 illustrates an insurance claim document input process 500 in accordance with some embodiments. Upon completion of sorting at 510 and scanning at 520, key data on the document may be indexed and used to match the document to a case file via the service layer 430. The document may also be classified into a document category and type. This document category and type, along with other metadata, may be sent to work management software at 530 that drives the routing and delivery of the document to the appropriate users for further processing. The scanned image of the document and its index information may be stored in a client profiles file storage system 546 of a resource layer 460 of a litigation management application 540. Data may also be stored in an application server 542 and a database server 544. Users can view/access these documents from the client profiles application via the data access layer 450 using legal office staff devices 550.

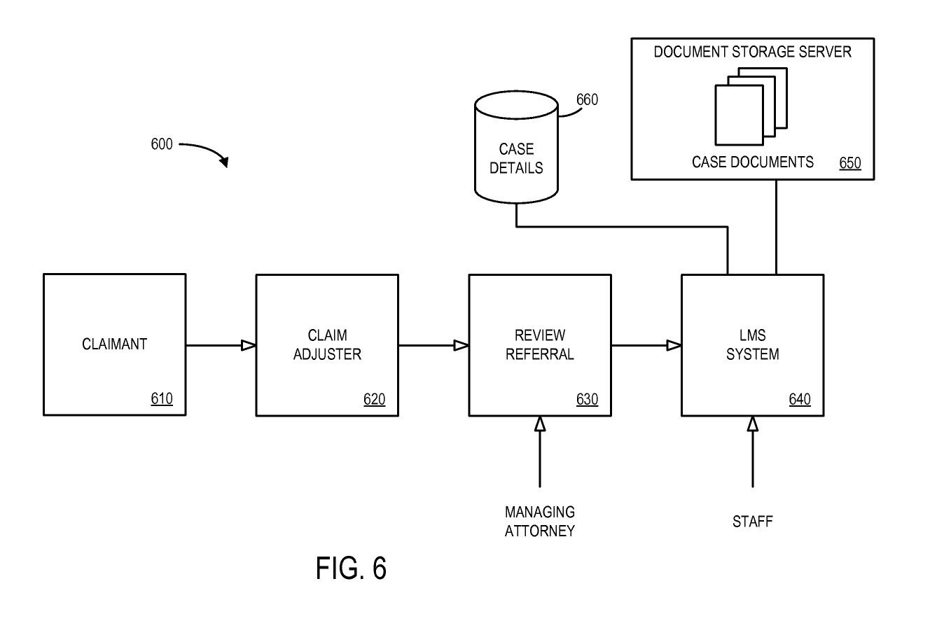

FIG. 6 is a block diagram of a data flow 600 according to some embodiments of the present invention. Initially, a claimant 610 might file a claim with a claim handler or adjuster 620. The claim adjuster 620 might provide a legal referral to a review process 630 handled by a managing attorney. Data may then be provided to a litigation management system 640 supported by staff and case documents may be stored at a document storage server 650 while case details are stored in a case details database 660.

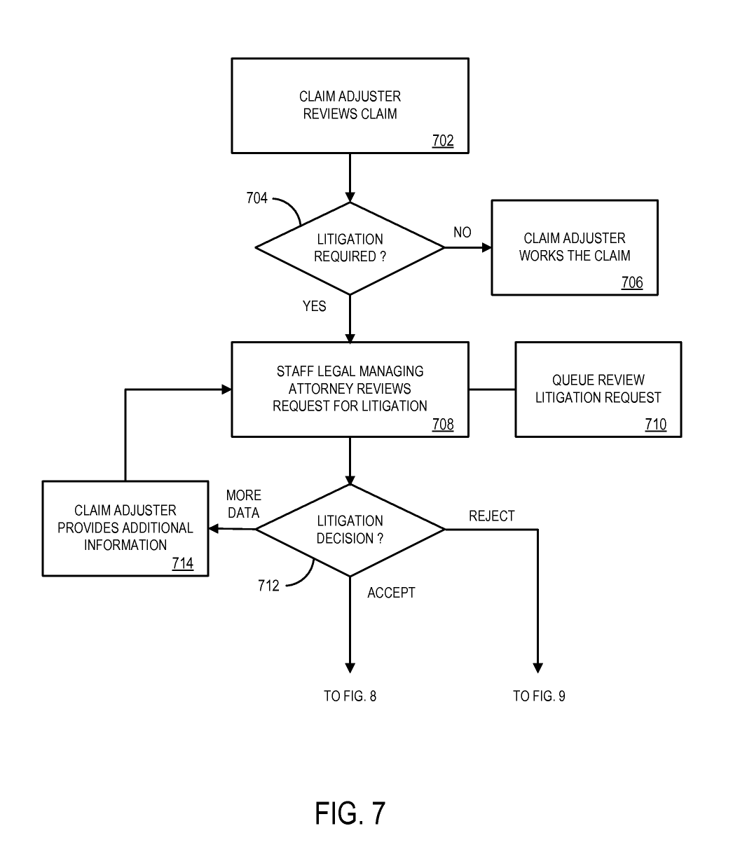

FIGS. 7 through 9 illustrate a more detailed insurance claim processing flow in accordance with some embodiments. At 702, a claim adjuster reviews a claim. If it is determined that litigation is not required at 704, the claims adjuster can simply work the claim at 706 and the process ends. If it is determined that litigation is required at 704, the staff legal managing attorney reviews the request for litigation at 708 (and a review litigation request may be queued at 710). If a litigation decision of “more data” is generated at 712, the claim adjuster may provide additional information at 714 and the process continues at 708.

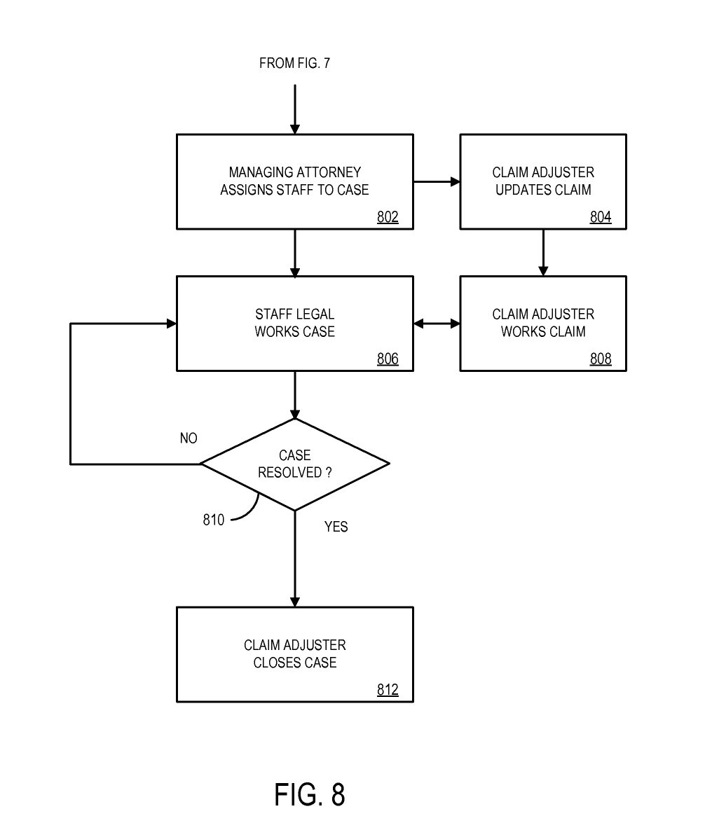

If a litigation decision of “accept” is generated at 712, the process continues at FIG. 8 and the managing attorney assigns staff to the case at 802. The claim adjuster updates the claim at 804. The staff legal may work the case at 806 and the claim adjuster may simultaneously work the case at 808 (and note that certain types of information may be exchanged between them during this process). The process continues until the case is resolved at 810, at which point the claim adjuster closes the case at 812.

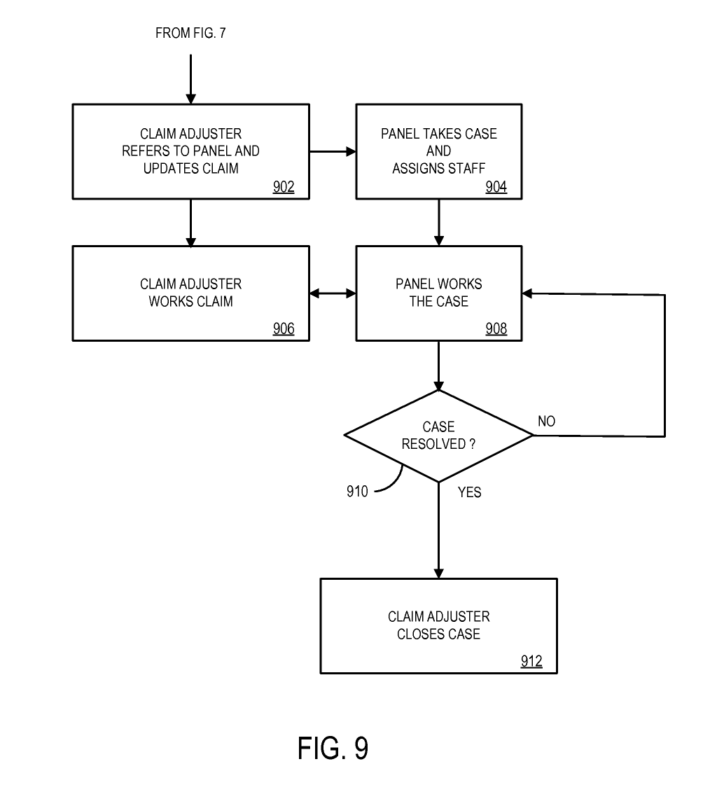

If a litigation decision of “reject” is generated at 712, the process continues at FIG. 9 and the claim adjuster may refer the case to a panel at 902. The panel may take the case and assign staff at 904. The claim adjuster may work the case at 906 and the panel may simultaneously work the case at 908 (and note that certain types of information may be exchanged between them during this process). The process continues until the case is resolved at 910, at which point the claim adjuster closes the case at 912.

Thus, various parties may need to exchange information while processing a claim. According to some embodiments of the present invention, integration with user applications, such as Microsoft Outlook® and Microsoft Exchange Server®, may facilitate these exchanges. The integration may also provide an ability to synchronize contacts between client profiles and users' contact list in Outlook®.

According to some embodiments, the client profiles Outlook/Exchange® integrations work via custom Messaging Application Programming Interface (“MAPI”) properties that are placed on Outlook® messages (e.g., emails, appointments, and contacts). An add-in that runs inside of Outlook may give the user appropriate UI interaction to associate Outlook® items with the appropriate matter in client profiles. Custom properties may be placed on the message when this association occurs. The actual application/services that process this information may vary based on whether the item is an email item, appointment item, or contact item.

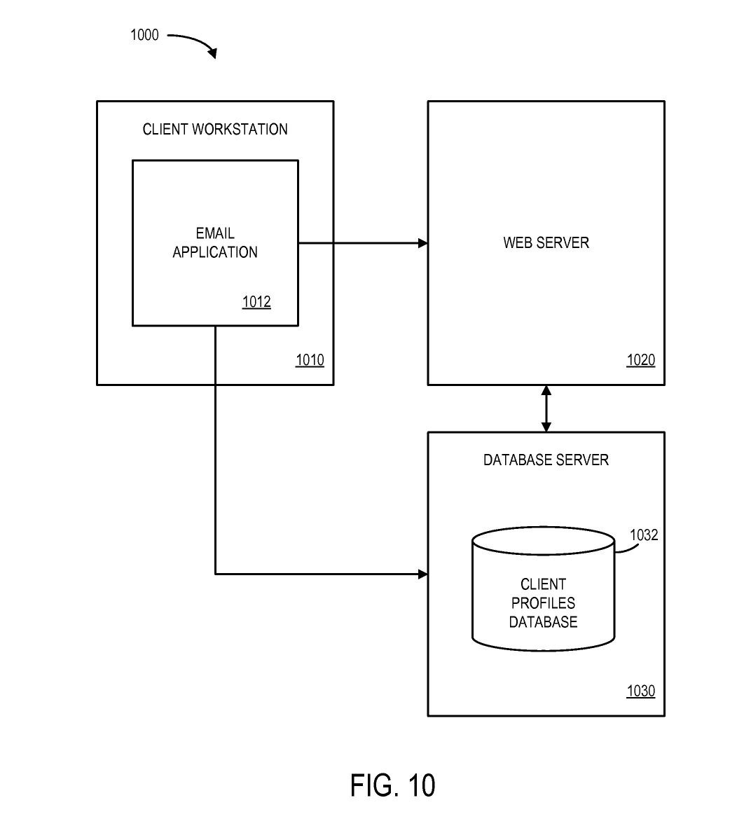

FIG. 10 illustrates a system 1000 wherein a litigation management system is integrated with an email application according to some embodiments. In particular, a client workstation 1010 includes an email application that provides data to a web server 1020 and a database server 1030. When a user associates an email item to a matter in Outlook®, custom MAPI properties may be placed on the email message. There may be a task tray application that resides on the workstation 1010 that facilitates the communication with a server-side web service. The job of the web service may be to record and store the incoming email message. The message may then indexed by a client profiles indexing service. A database record may be created (e.g., in a client profiles database 1032) that stores just enough information about the actual email item so that a list of messages can be displayed to the end user inside the matter. The actual .MSG file may be stored as a physical file on the network. Once the file is saved to the network it may also be indexed, making it available for ad-hoc searching within the matter. The web servicer 1020 may also be responsible for streaming stored email messages down the client workstations 1010 if a user wants to view the entire email message that is related to a matter.

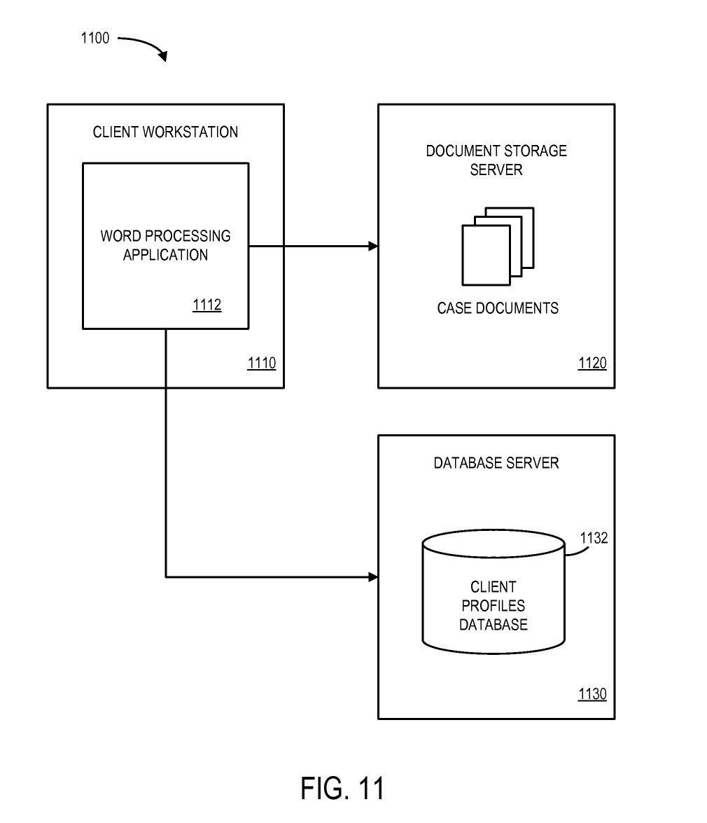

FIG. 11 illustrates a system 1100 wherein a litigation management system is integrated with a word processing application according to some embodiments of the present invention. In particular, a client workstation 1110 includes a word processing application that provides data to a document storage server 1120 (storing case documents) and a database server 1130 (storing a client profiles database 1132). Note that an Office® integration might include a Microsoft Outlook® add-in, a Microsoft Word® add-in, and a client application, the task tray, which runs in the system notification area. Both add-ins may be loaded with the startup of their respective Office® application and operate by customizing the application's user interface, putting the functionality of client profiles right into Microsoft Office®. The components may be installed to the local workstation in the same directory as a case management client.

For all case management related operations, the Office® integration components may interact directly with the case management database. In order to authenticate the user, the add-ins may utilize the user's active directory information (SID—Security Identifier) to establish his or her client profiles identity. This mapping might be configured in the case management user setup, and may be required for the Office® integration to function.

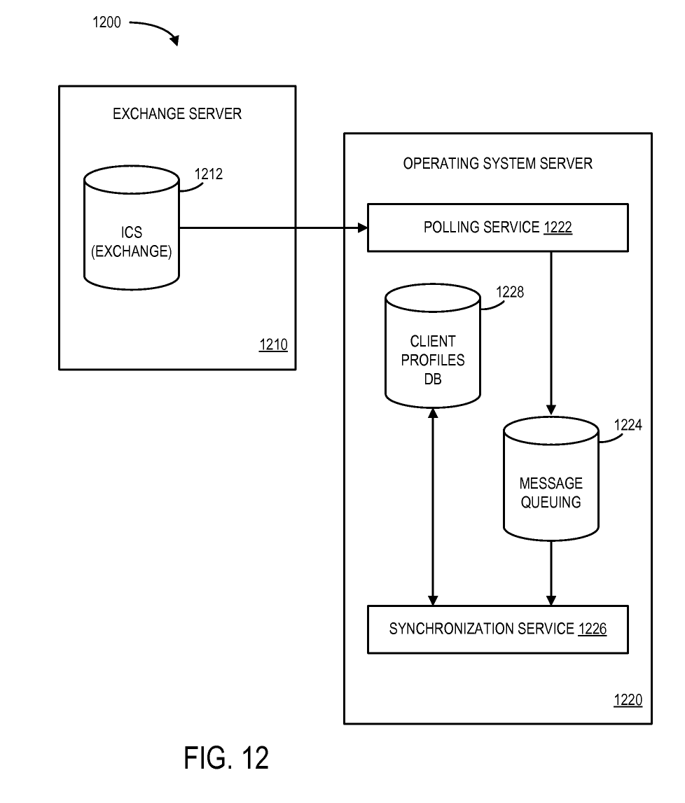

FIG. 12 illustrates a system 1200 wherein a litigation management system is integrated with a calendaring application according to some embodiments. In particular an Exchange® server 1210 provides data to an operating system server 1220, such as a Window® server. Note that the architecture for appointment integration may be significantly different than that of emails. With emails, the integration may be captured and processed at a specific point in time when the user associates the email to a matter in Outlook®. With appointments, the system 1200 may need to capture every change to calendar data, not just items related to matters. This might be done so that client profiles can provide additional insight into user calendar data as it relates to multi-user scheduling. In order to accomplish this level of integration, a Microsoft provided technology called Incremental Change Synchronization (“ICS”) 1212 may be used.

To achieve this integration, there may be two services involved, including a polling service 1222 that may be responsible for communicating directly with the Exchange® Server 1210 via MAPI. Each polling service installation may be configured to handle a specified number of mailboxes. As changes are received, they can be placed in a MSMQ 1224. The second service may be a client profiles synchronization service 1226. This service 1226 may be responsible for processing the items that are placed in the MSMQ 1224. This may represent all of the insert/update/delete activity for appointments that are changing in Outlook®. The service 1226 may retrieve the necessary information about the appointment/meeting directly from the appropriate Exchange® mail store and synchronizes the data in a client profiles database 1228 with the data in Microsoft Outlook®. If there are custom properties on the appointment message that relate it to a matter, the service 1226 may takes this into account during the synchronization process.

A contact integration architecture may be very similar to what was described for the appointment integration. The same two services may be involved, the polling service and the synchronization service. One difference in the architecture for contacts might be that changes can flow both ways. Changes to contact records in the client profiles application or changes to records in Outlook® might synchronize both ways. Note that changes to corporate contact records (as opposed to personal contact records) might only flow one way (from client profiles to Outlook®).

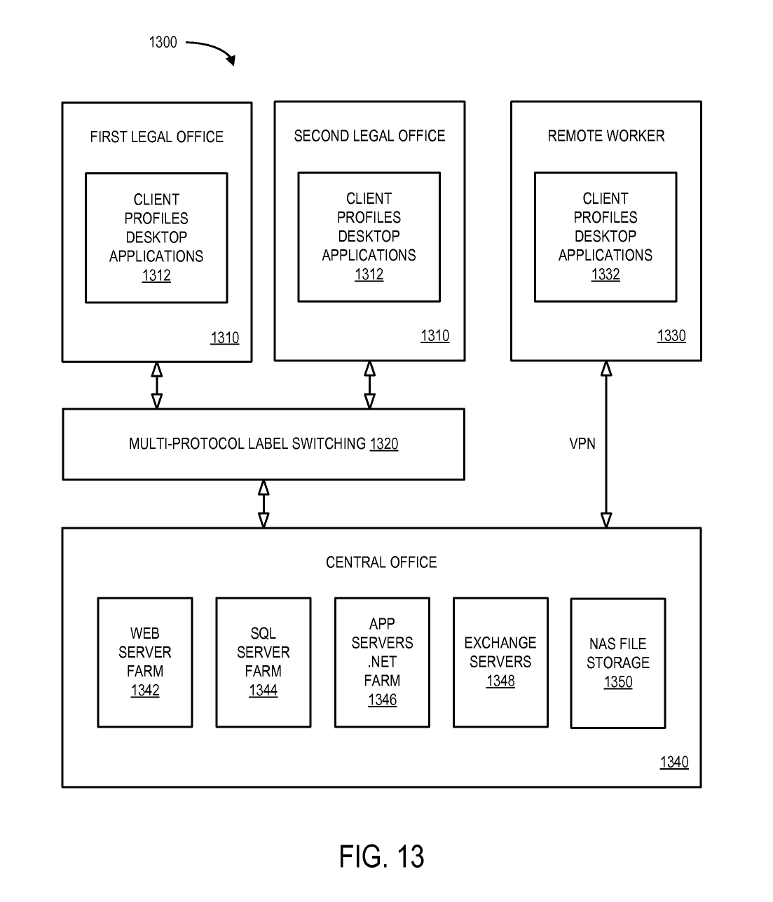

FIG. 13 is a system diagram 1300 demonstrating connections between litigation management system components according to some embodiments. According to this embodiment, a number of remote legal offices 1310 executing client profiles desktop applications 1312 communicate via Multi-Protocol Label Switching (“MPLS”) 1320 with a central office 1340. Similarly, a remote worker 1330 executing a client profiles desktop application 1332 may communicate via a Virtual Private Network (“VPN”) with the central office 1340. Note that the central office 1340 and the remote worker 1330 might communicate in ways other than those illustrated in FIG. 13, such as via the CITRIX® or VMware® communication approaches. The central office 1340 might support, for example, a web server farm 1342, an SQL server farm 1344, an application server .NET farm 1346, Exchange® servers, and Network Attached Storage (“NAS”) file servers 1350.

According to some embodiments, an authentication desktop application may be required for user's to access an enterprise's intranet (including user name and password protection). An authorization desktop application may also be installed on the user's physical or virtual desktop. For example, a user might need to be added to an application by a designated individual. Once the user has been added, the user may be given a role suitable to the work that is to be performed.

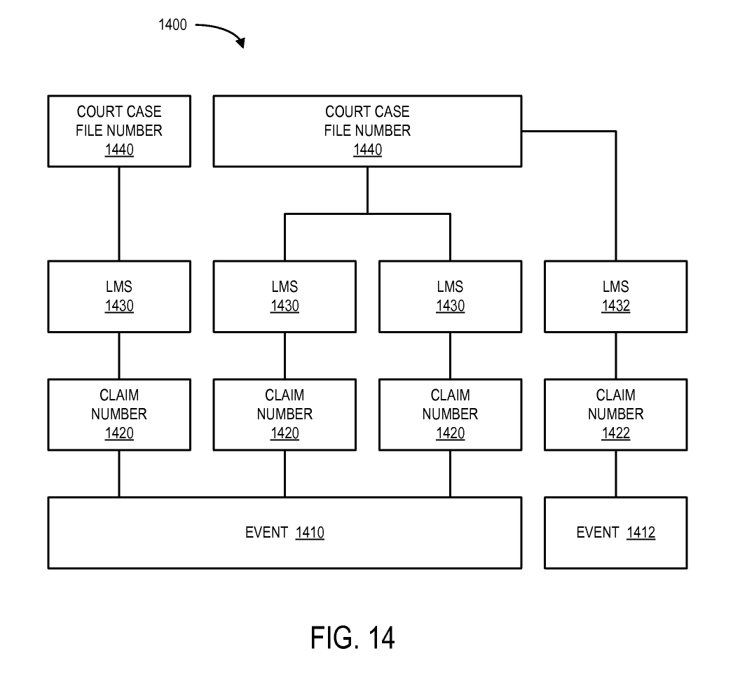

FIG. 14 is a business model view 1400 associated with a litigation management system according to some embodiments of the present invention. In this case, an event 1410 might be associated with a several different claim numbers 1420 (e.g., each representing an individual involved in an automobile accident). Each claim number 1420 might be linked to a litigation management system identifier 1430, which, in turn, may be associated with a court case file number 1440. Note that different claim numbers 1420 could be linked to different court cast numbers 1440, and potentially, different events could be associated with a single court case file number 1440 (illustrated by event 1412, claim number 1422, and litigation management system identifier 1432).

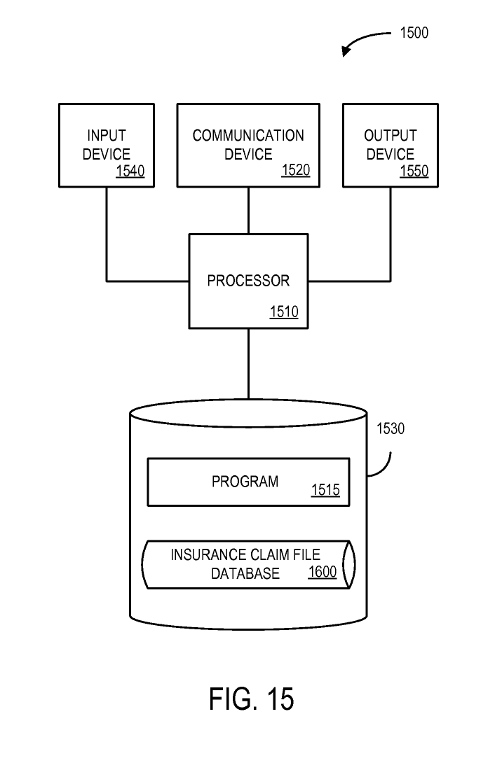

FIG. 15 is a block diagram of a litigation management apparatus 1500 in accordance with some embodiments of the present invention. The apparatus 1500 might, for example, comprise a platform or engine similar to the central litigation management system server 110 illustrated in FIG. 1. The apparatus 1500 comprises a processor 1510, such as one or more INTEL° Pentium® processors, coupled to a communication device 1520 configured to communicate via a communication network (not shown in FIG. 15). The communication device 1520 may be used to exchange insurance claim information, for example, with one or more remote devices.

The processor 1510 is also in communication with an input device 1540. The input device 1540 may comprise, for example, a keyboard, a mouse, or computer media reader. Such an input device 1540 may be used, for example, to enter information about claims, legal representatives, and adjusters. The processor 1510 is also in communication with an output device 1550. The output device 1550 may comprise, for example, a display screen or printer. Such an output device 1550 may be used, for example, to provide reports and/or display information associated with insurance claim files.

The processor 1510 is also in communication with a storage device 1530. The storage device 1530 may comprise any appropriate information storage device, including combinations of magnetic storage devices (e.g., hard disk drives), optical storage devices, and/or semiconductor memory devices such as Random Access Memory (RAM) devices and Read Only Memory (ROM) devices. The storage device 1530 stores a program 1515 for controlling the processor 1510. The processor 1510 performs instructions of the program 1515, and thereby operates in accordance any embodiments of the present invention described herein. For example, the processor 1510 may, for each of a plurality of insurance claims, establish an insurance claim file and associate it with: (i) a potential litigation, (ii) a remote legal representative, and (iii) a remote claim adjuster. Hours associated with the remote legal representative may be tracked by the processor 1510 and allocated to insurance claim files as appropriate. Legal events associated with the potential litigation may also be tracked by the processor 1510, wherein at least some of the legal events are associated with a stored document accessible to the legal representative and not accessible to the claim adjuster. A first legal event associated with a first insurance claim file may be evaluated by the processor 1510 based on a pre-determined rule, and, responsive to the evaluation, an alert may be transmitted via the communication device 1520 to the remote claim adjuster associated with the first insurance claim file.

As used herein, information may be “received” by or “transmitted” to, for example: (i) the litigation management apparatus 1500 from other devices; or (ii) a software application or module within the litigation management apparatus 1500 from another software application, module, or any other source.

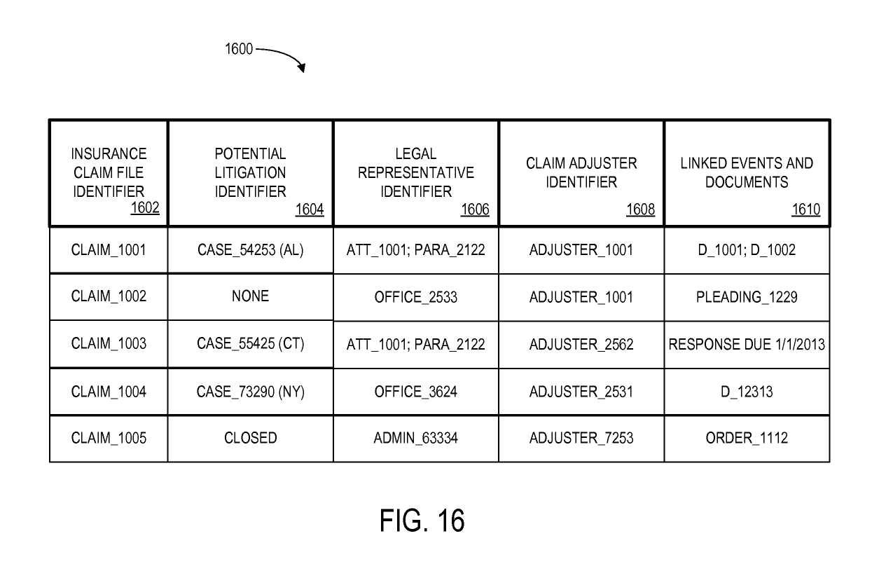

As shown in FIG. 15, the storage device 1530 also stores an insurance claim file database 1600. One example of such a database 1600 that may be used in connection with the litigation management apparatus 1500 will now be described in detail with respect to FIG. 16. The illustration and accompanying descriptions of the database presented herein are exemplary, and any number of other database arrangements could be employed besides those suggested by the figures. For example, different databases associated with different types of policies or appointments might be associated with the apparatus 1500.

FIG. 16 is a tabular view of a portion of the new work notification database 1600 in accordance with some embodiments of the present invention. The table includes entries associated with new insurance policies that have been sold by producers. The table also defines fields 1602, 1604, 1606, 1608, 1610 for each of the entries. The fields specify: an insurance claim file identifier 1602, a potential litigation identifier 1604, a legal representative identifier 1606, a claim adjuster identifier 1608, and linked events and documents 1610. The information in the database 1600 may be periodically created and updated based on information received from legal representative devices, claim adjuster devices, and/or third-party devices (e.g., a document scanning service).

The insurance claim file identifier 1602 might be, for example, an alphanumeric code that uniquely identifies an insurance claim currently being processed. The potential litigation identifier 1604 might indicate, for example, a court case and/or jurisdiction associated with that claim file. The legal representative and claim adjuster identifiers 1606, 1608 might indicate the people, offices, and/or roles work are currently working on the claim file. The linked events and documents 1610 might, for example, point to word processing documents, spreadsheets, and/or images associated with the insurance claim file (e.g., relevant medical records and court documents).

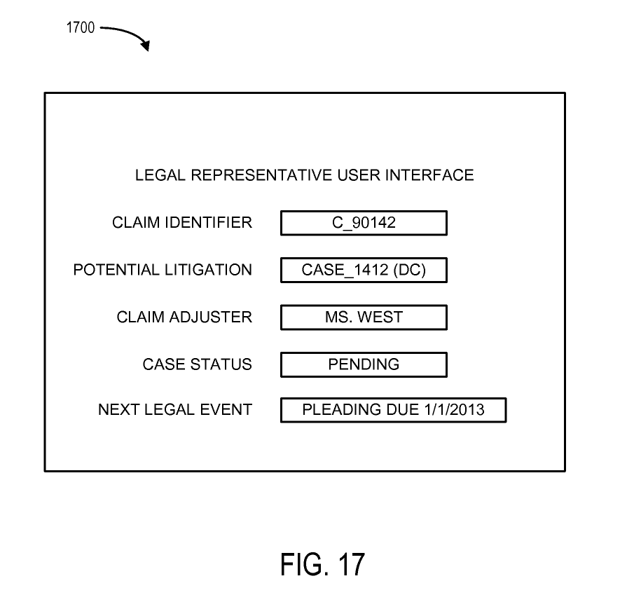

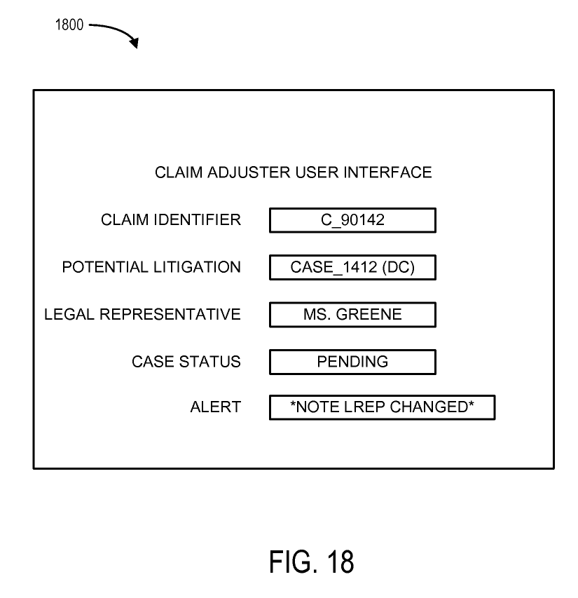

FIG. 17 is an example of a legal representative GUI display 1700 according to some embodiments. The display 1700 might include, for example, a claim identifier, a potential litigation, a claim adjuster, a case status, and an upcoming legal event. The display 1700 might further include, according to some embodiments, a list of documents that are associated with the claim file and available to the legal representative. FIG. 18 is an example of a claim adjuster GUI display 1800 according to some embodiments. The display 1800 might include, for example, a claim identifier, a potential litigation, a legal representative, a case status, and an alert message. The display 1800 might further include, according to some embodiments, a list of documents that are associated with the claim file and available to the claim adjuster. Note that the set of documents available to the claim adjuster might be different than the set of documents available to the legal representative. For example, according to some embodiments, legal representatives and claims adjusters are each associated with completely separate document repositories that are not generally shared. In this case, a document might be shared or copied between the repositories only after being manually reviewed and approved by one or more appropriate parties.

As a result of the embodiments described herein, the efficiency and accuracy of litigation management may be improved for legal representatives, claim adjusters, an insurance company, and claimants.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with embodiments of the present invention (e.g., some of the information associated with the databases and engines described herein may be split, combined, and/or handled by external systems).

Applicants have discovered that embodiments described herein may be particularly useful in connection with automobile insurance claims, although embodiments may be used in connection other types of insurance claims (e.g., life insurance) claims. Moreover, although some embodiments have been described with respect to court litigation, note that embodiments might be useful in other dispute resolution situations.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed:

1. An automated central insurance litigation management system server, comprising:
a communication device to receive information about a plurality of insurance claims;
a processor coupled to the communication device; and
a storage device in communication with said processor and storing instructions adapted to be executed by said processor to:
for each of the plurality of insurance claims, establish an insurance claim file associated with: (i) a litigation matter, (ii) a remote legal representative, and (iii) a remote claim adjuster,
track hours associated with the remote legal representative and allocate the tracked hours to insurance claim files as appropriate,
track legal events associated with the litigation matter, wherein at least some of the legal events are associated with a stored document accessible to the legal representative and not accessible to the claim adjuster,
evaluate a first legal event associated with a first insurance claim file based on a pre-determined rule, and
responsive to the evaluation, transmit an alert to the remote claim adjuster associated with the first insurance claim file, wherein the alert is transmitted via a communication network to facilitate a display of the alert on a display device of the remote claim adjuster.

2. The server of claim 1, wherein insurance claims processed by the server include with at least two of: (i) a property and causality insurance claimant, (ii) a property and casualty insurance defendant, (iii) a workers compensation claim, or (iv) an automobile insurance claim.

3. The server of claim 1, wherein the remote legal representative is associated with at least one of: (i) an attorney, (ii) a paralegal, (iii) a legal secretary, or (iv) an administrator.

4. The server of claim 1, wherein the tracked hours associated with the remote legal representative are allocated to insurance claim files in accordance with at least one compliance rule and at least one of the tracked legal events.

5. The server of claim 1, wherein at least one of the legal events is associated with at least one of: (i) a court calendar or docket date, (ii) a response deadline, (iii) a court ruling, or (iv) a court order.

6. The server of claim 1, wherein the stored document is associated with at least three of: (i) an interrogatory, (ii) a court pleading, (iii) a medical document, (iv) an accident report, (v) a police record, (vi) a deposition, (vii) a court ruling, or (viii) a court order.

7. The server of claim 1, wherein the alert transmitted to the remote claim adjuster is associated with at least one of: (i) an email message, (ii) a change in the legal representative, or (iii) a reminder associated with a legal event.

8. The server of claim 1, wherein the storage device further stores instructions adapted to be executed by said processor to:
generate a report associated with at least one of: (i) a quality scorecard, (ii) a financial average, or (iii) a cycle time average.

9. The server of claim 8, wherein the report represents information gathered across at least one of: (i) a plurality of remote legal representatives, (ii) a plurality of remote claim adjusters, or (iii) a plurality of insurance claim types.

10. A computer-implemented method to facilitate litigation management, comprising:
for each of a plurality of insurance claims, establishing, by a processor, an insurance claim file to be stored in connection with: (i) a litigation matter, (ii) a remote legal representative, and (iii) a remote claim adjuster;
tracking, by the processor, hours associated with the remote legal representative and allocating the tracked hours to insurance claim files as appropriate;
storing, by the processor, a document in a database in connection with an insurance claim file, wherein the stored document is accessible to the legal representative and not accessible to the claim adjuster;
tracking, by the processor, legal events associated with the litigation matter, wherein at least some of the legal events are associated with the stored document;
automatically evaluating, by the processor, a first legal event associated with a first insurance claim file based on a pre-determined rule; and
responsive to the evaluation, transmitting an alert to the remote claim adjuster device associated with the first insurance claim file.

11. The method of claim 10, wherein the tracked hours associated with the remote legal representative are allocated to insurance claim files in accordance with at least one compliance rule.

12. The method of claim 10, wherein at least one of the legal events is associated with at least one of: (i) a court calendar or docket date, (ii) a response deadline, (iii) a court ruling, or (iv) a court order.

13. The method of claim 10, wherein the storage device further stores instructions adapted to be executed by said processor to:
generate a report associated with at least one of: (i) a quality scorecard, (ii) a financial average, or (iii) a cycle time average.

14. The method of claim 13, wherein the report represents information gathered across at least one of: (i) a plurality of remote legal representatives, (ii) a plurality of remote claim adjusters, or (iii) a plurality of insurance claim types.

15. An insurance litigation management system, comprising:
a document input engine to generate document files for a plurality of insurance claim files, wherein each insurance claim file is associated with: (i) a litigation matter, (ii) a remote legal representative, and (iii) a remote claim adjuster;
a client profile engine to: (i) track hours associated with the remote legal representative and allocate the tracked hours to the insurance claim files as appropriate, (ii) track legal events associated with the litigation matters, wherein at least some of the legal events are associated with a stored document accessible to the legal representative and not accessible to the claim adjuster, (iii) evaluate a first legal event associated with a first insurance claim file based on a pre-determined rule, and (iv) responsive to the evaluation, transmit an alert to the remote claim adjuster associated with the first insurance claim file; and
a resources layer to store the client profiles and the generated document files.

16. The system of claim 15, wherein the client profile engine further includes an interface to a third-party court calendaring service.

17. The system of claim 15, wherein the client profile engine further includes an interface to at least one of: (i) a word processing application, (ii) an email application, (iii) a contact management application, or (iv) a user calendar application.

18. The system of claim 15, wherein the client profile engine further executes legal conflict of interest avoidance rules.

19. The system of claim 15, further comprising:
an access layer to support a graphical user interface for at least one of: (i) the remote legal representative, or (ii) the remote claims adjuster.

20. The system of claim 15, wherein the client profile engine further generates reports associated with at least two of: (i) a quality scorecard, (ii) a financial average, (iii) a cycle time average, (iv) a plurality of remote legal representatives, (v) a plurality of remote claim adjusters, or (vi) a plurality of insurance claim types.
